(19) United States
(12) Patent Application Publication
(10) Pub. No.: US 2013/0290365 A1
(43) Pub. Date: Oct. 31, 2013

(54) COMPONENT MANAGEMENT APPARATUS, COMPONENT MANAGEMENT METHOD AND NON-TRANSITORY STORAGE MEDIUM

(71) Applicants: Mitsuteru Tanoue, Tokyo (JP); Hajime Eda, Osaka (JP); Yumiko Fujimoto, Osaka (JP)

(72) Inventors: Mitsuteru Tanoue, Tokyo (JP); Hajime Eda, Osaka (JP); Yumiko Fujimoto, Osaka (JP)

(73) Assignees: NEC SYSTEM TECHNOLOGIES, LTD., Osaka-shi, Osaka (JP); NEC CORPORATION, Minato-ku, Tokyo (JP)

(21) Appl. No.: 13/980,805

(22) PCT Filed: Nov. 29, 2011
(86) PCT No.: PCT/JP2011/006635

§ 371 Date: Jul. 19, 2013

(30) Foreign Application Priority Data
Jan. 20, 2011 (JP) 2011-010105

(51) Int. Cl. G06F 17/30

(52) U.S. Cl. CPC G06F 17/30386
USPC 707/758

(57) ABSTRACT

In order to solve a problem to provide means for facilitating creation and management of a component table, there is provided a component management apparatus which arranges and manages components of a plurality of products, arranges and manages common components that are common in all of the plurality of products and optional components which are different for each product, associates and manages the optional components with specific requirements that are set for each product to determine whether to use the optional components, and manages specific requirements that are associated with each product and set for each product.

### TECHNICAL FIELD

The present invention relates to a component management apparatus, a component management method and a program.

### BACKGROUND ART

For example, it is necessary for product manufacturing companies to manage components constituting of each product. As means for managing components, means for managing components for each product is considered. That is, data that arranges components for each product is created and managed.

However, some products may include components common to other products (hereinafter, referred to as “common components”), and even in some products, large number of components constituting the products are common components and only a small number of components are components different from the components of other products (hereinafter, referred to as “optional components”). In component management of such a product group, if data that arranges components for each product is created and managed, common components are repeatedly managed in data of plurality of products, thus, this results in inconvenience such as an increase in data amount.

As means for resolving the inconvenience, Patent Document 1 discloses a component table management apparatus including: parent component table storage means for storing a parent component table having component numbers of components that are common to all similar products and a product inherent number for each product that is applied to the component numbers of components that are different for each product, and data relating to numbers of the parent component table; child component table number input means for inputting child component table numbers that are made by applying the product inherent numbers to the parent component table numbers; parent component table search means for searching the parent component tables corresponding to the parent component table numbers that are input from the child component table number input means, among data of the parent component table storage means; component number extraction means for extracting component numbers to which the product inherent number, that is input from the child component table number input means, is applied and the component numbers of the common components, from the parent component table that is searched in the parent component table search unit; and child component table output means for outputting the component numbers that are extracted in the component number extraction means as a component table of a product corresponding to the product inherent number that is input from the child component table number input means.

### RELATED DOCUMENT

### Patent Document

[Patent Document 1] Japanese Unexamined Patent Publication No. 2001-344007

### DISCLOSURE OF THE INVENTION

The present inventors have found that the following problems are present in a technology described in Patent Document 1.

In the technology described in Patent Document 1, in the parent component table which arranges and manages the component numbers of the common components and the optional components, the number inherent to each product (product inherent number) is applied to the component number of each optional component. That is, in the parent component table, each product and optional components are directly associated.

Then, when predetermined information is extracted from the parent component table to create a component table of a first product, the component numbers of the common components are extracted and the component numbers of the optional components, to which the product inherent number of the first product is applied, are extracted.

As the technology described in Patent Document 1, in a case where the product and the optional components are directly associated in the parent component table, it is not possible to create a component table of a product (hereinafter, referred to as “unassociated product”) which are not directly associated with the optional components in the parent component table. For example, even if the unassociated product uses all common components and uses a part of the optional components, that are managed in the parent component table, since the unassociated product and the optional components are not associated in the parent component table, it is not possible to create the component table of the unassociated product from the parent component table. In order to create the component table of the unassociated product, it needs to apply the product inherent number of the unassociated product to the component numbers of the optional components used by the unassociated product, in the parent component table.

That is, in a case of the technology described in Patent Document 1, in order to create the component table of the products which are not directly associated with the predetermined optional components in the parent component table, it needs to change the content of the parent component table. Since the parent component table is data as a basis for creating the component table of each product, it is not preferable to frequently change the parent component table. Further, in a case where a large number of components are managed in the parent component table, the data amount is increased, which results in data change operation requiring a great deal of operation time, and errors are likely to occur with the changed content. Moreover, it is considered that when an error happens in the changed content, there is an inconvenience in that it takes a great deal of efforts to recover the errors. In addition, for example, new products related to the product of which components are managed in the parent component table are considered as the unassociated product, thus the unassociated product is likely to occur relatively frequently.

Therefore, an object of the present invention is to provide means for facilitating a creation and management of a component table.

In the present invention, in the same manner as the technology described in Patent Document 1, it is possible to arrange and manage components of a plurality of products. Further, it is possible to arrange and manage common components that are used commonly in a plurality of products (hereinafter, referred to as “management product group”) that are arranged and managed, and optional components. However, in the present invention, each product and optional components used in each product are not directly associated.

The present inventor has found that whether or not optional components are used in each product is determined according to specific requirements that are set for each product.

For example, a DVD drive “product number: AAA-d” is an optional component that is commonly used in products which have a built-in DVD drive among the management product group, and whether or not the “product number: AAA-d” is used in a first product is determined depending on whether or not the first product has a specification which has a built-in DVD drive.

Further, a first CD drive “product number: BBB-c” (made in USA) is commonly used in products which have a built-in CD drive and of which the destination area is the USA, among the management product group, and whether or not the “product number: BBB-c” is used in the first product is determined depending on whether or not the first product has a specification which has a built-in CD drive and whether or not the destination area of the first product is the USA.

Further, a second CD drive “product number: CCC-c” (made in Japan) is commonly used in products which have a built-in CD drive and of which the destination area is Japan, among the management product group, and whether or not the “product number: CCC-c” is used in the first product is determined depending on whether or not the first product has a specification which has a built-in CD drive and whether or not the destination area of the first product is Japan.

In this manner, whether or not optional components are used in each product is determined depending on the specific requirements that are set for each product, for example, whether or not the specification has a built-in DVD drive, whether or not the specification has a built-in CD drive, where a destination area is, and the like. Further, among the optional components, whether to use some optional components may be determined depending on one requirement specific to each product, as the DVD drive “product number: AAA-d”, in contrast, whether or not to use some optional components may be determined depending on two or more requirements specific to each product, as the first and second CD drives.

The present inventor completes the following invention based on the above premise.

That is, in the present invention, in “component information” which is used to arrange and manage common components and optional components, the value of at least one of the optional items is associated with each of the optional components and managed. The value of the optional items is the requirement to determine whether or not to use the optional components, and corresponds to “destination area: USA”, “destination area: Japan”, “built-in CD drive”, “built-in DVD drive”, and the like in the above example.

Further, in the present invention, information which is used to identify each product among the management product group, and the value of at least one of optional items which represents a specific requirement that is set for each product are associated and managed as “product information.” In addition, the value of the optional items may not be associated with identification information of the product without using the optional component.

In a case of creating the component table of the first product using the component information, product information is firstly searched and the value of optional items of the first product, that is, the requirement specific to the first product is identified. Then, the component information is searched using the value of the identified optional items, thus components included in the first product are extracted.

For example, the optional components, that all values of the associated optional items (in a case of the first CD drive “product number: BBB-c”, “destination area: USA”, and “built-in CD drive”) are included in the values of the optional items of the first product, and common components are extracted as the components included in the first product.

According to the present invention, it is possible to facilitate a creation and management of a component table. For example, in a case where a new product comes out, which uses all common components that are registered in component information and uses a part of optional components that are registered in advance in the component information, if information which is used to identify the new product and the values of at least one of the optional items indicating requirements specific to the new product are associated with and newly registered in the product information, it is possible to create a component table of the new product without changing the content of the component information. That is, it is not necessary to change the content of the component information whenever the new product comes out.

Further, according to the present invention, there is provided a component management apparatus which arranges and manages components of a plurality of products including: a component information holding unit that holds component information in which component identification information of common components that are common in all of the plurality of products among the components and component identification information of optional components which are different for each product among the components are listed, and option information including a value of at least one of optional items is associated with the component identification information of the optional components; a product information holding unit that holds product information in which product identification information of each of the plurality of products is listed, and option designation information including a value of at least one of the optional items is associated with the product identification information of at least one of the products; an input receiving unit that receives an input to specify one of the product identification information; a product information search unit that searches the product information, using designated product identification information that is the product identification information specified by the input as a key, and acquires the option designation information associated with the designated product identification information, or information indicating that the option designation information is not associated with the designated product identification information, as a search result; and a component extraction unit that searches the component information, and extracts first component identification information that is the component identification information of the component of the product specified by the designated product identification information, in a case where the product information search unit acquires the option designation information as the search result, the component extraction unit extracts the component identification information in which the values of the associated optional items are included in the option designation information, as the first component identification information, among the component identification information with which the option information is associated.

Further, according to the present invention, there is provided a component management method which arranges and manages components of a plurality of products, the method including: in a state where component information and product information are stored in a memory, in the component information, component identification information of common components that are common in all of the plurality of products among the components and component identification information of optional components which are different for each product among the components are listed, and option information including a value of at least one of optional items is associated with the component identification information of the optional components, and in the product information, product identification information of each of the plurality of products is listed, and option designation information including a value of at least one of the optional items is associated with the product identification information of at least one of the products, an input receiving step that receives an input to specify one of the product identification information; a product information search step that searches the product information, using designated product identification information that is the product identification information specified by the input as a key, and acquires the option designation information associated with the designated product identification information, or information indicating that the option designation information is not associated with the designated product identification information, as a search result; and a component extraction step that searches the component information, and extracts first component identification information that is the component identification information of the component of the product specified by the designated product identification information, in a case where the product information search step acquires the option designation information as the search result, the component extraction step extracts the component identification information in which the values of the associated optional items are included in the option designation information, as the first component identification information, among the component identification information with which the option information is associated.

Further, according to the present invention, there is provided a program which arranges and manages components of a plurality of products, the program causing a computer to function as: a component information holding unit that holds component information in which component identification information of common components that are common in all of the plurality of products among the components and component identification information of optional components which are different for each product among the components are listed, and option information including a value of at least one of optional items is associated with the component identification information of the optional components; a product information holding unit that holds product information in which product identification information of each of the plurality of products is listed, and option designation information including a value of at least one of the optional items is associated with the product identification information of at least one of the products; an input receiving unit that receives an input to specify one of the product identification information; a product information search unit that searches the product information, using designated product identification information that is the product identification information specified by the input as a key, and acquires the option designation information associated with the designated product identification information, or information indicating that the option designation information is not associated with the designated product identification information, as a search result; and a component extraction unit that searches the component information, and extracts first component identification information that is the component identification information of the component of the product specified by the designated product identification information, in a case where the product information search unit acquires the option designation information as the search result, the component extraction unit is caused to function in order to extract the component identification information in which the values of the associated optional items are included in the option designation information, as the first component identification information, among the component identification information with which the option information is associated.

According to the present invention, it is possible to facilitate creation and management of a component table.

### BRIEF DESCRIPTION OF THE DRAWINGS

These and other objects, features, and advantages of the invention will be apparent through reference to the description of preferred embodiments and accompanying drawings.

FIG. 1 is an example of a functional block diagram of a component management apparatus of the embodiment.

FIG. 2 is an example of component information of the embodiment.

FIG. 3 is an example of product information of the embodiment.

FIG. 4 is an example of a component table that is created by the embodiment.

FIG. 5 is an example of a component table that is created by the embodiment.

FIG. 6 is an example of a component table that is created by the embodiment.

FIG. 7 is an example of a component table that is created by the embodiment.

FIG. 8 is an example of a component table that is created by the embodiment.

FIG. 9 is an example of a component table that is created by the embodiment.

FIG. 10 is a flowchart illustrating an example of a process flow of a component management method of the embodiment.

### DESCRIPTION OF EMBODIMENTS

Hereinafter, embodiments of the present invention will be described referring to drawings.

In addition, each unit of the embodiments is realized by any combination of software and hardware, that is, mainly a CPU of a computer, a memory, a program loaded on the memory (including programs downloaded from storage media such as CDs or from servers on the internet in addition to programs stored in advance in a memory in a stage of shipping a product), a memory unit such as a hard disc for storing the program, and an interface for network connection. Then, it is obvious to those skilled in this field that various variation examples are available in realizing methods and devices.

Further, the functional block diagrams used in a description of the embodiment do not illustrate a configuration in the hardware unit, but illustrate a block in function unit. In the figures, it is illustrated that each device of the embodiments is realized as a device, but realizing means is not limited thereto. That is, a physically divided configuration and logically divided configuration may be employed.

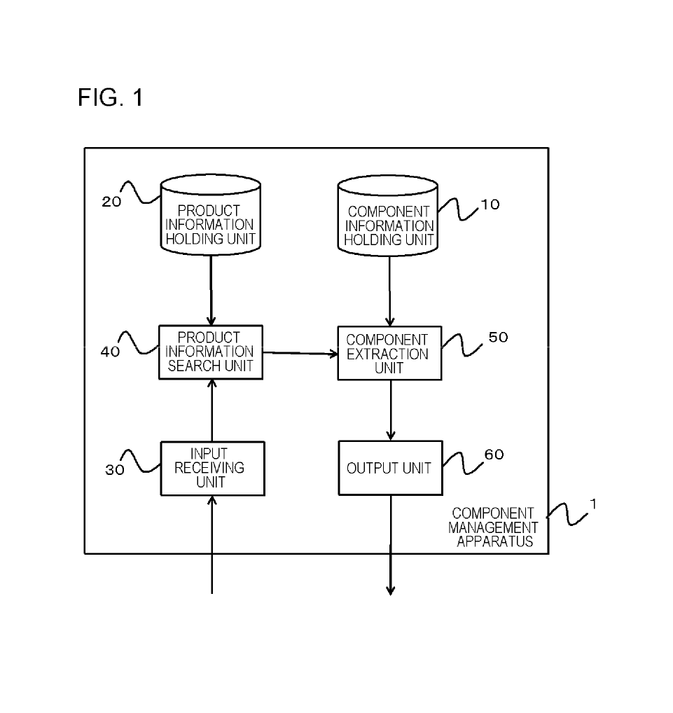

FIG. 1 is a functional block diagram illustrating an example of a configuration of a component management apparatus 1 of the embodiment. The component management apparatus 1 of the embodiment includes a component information holding unit 10, a product information holding unit 20, an input receiving unit 30, a product information search unit 40, a component extraction unit 50, and an output unit 60 in order to arrange and manage components of a plurality of products. Hereinafter, each unit will be described.

The component information holding unit 10 holds component information. The component information includes a list of component identification information which identifies common components that are components common in all of a plurality of products included in a management product group and component identification information of optional components that are components different for each product. Then, component identification information of the optional components is associated with option information including the value of at least one of the optional items. Further, the optional components are components other than the common components, and components which are used in a part (1 or 2 or more) of products among the management product group.

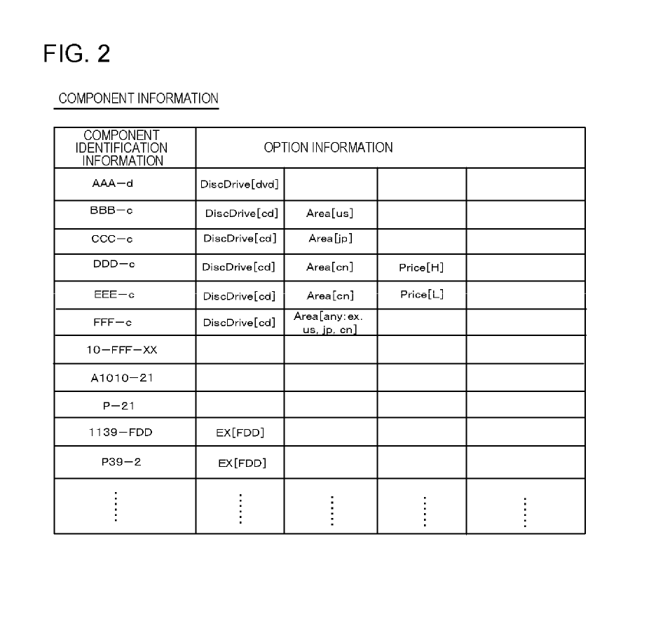

FIG. 2 illustrates an example of component information. In the component information shown in FIG. 2, component identification information of each of the plurality of components is described in a column of the component identification information. Then, optional item identification information which identifies optional items and the value of the optional items are associated with and described in a column of option information.

For example, optional item identification information “DiscDrive” with the value of optional item “dvd” is associated with component identification information “AAA-d”. This shows that the components specified by the component identification information “AAA-d” are commonly used in products in which a DVD drive is set as the specification of DiscDrive, among the management product group.

Option item identification information “DiscDrive” with the value of optional item “cd”, and optional item identification information “Area” with the value of optional item “us” are associated with component identification information “BBB-c”. This shows that the components specified by the component identification information “BBB-c” are commonly used in products in which a CD drive is set as the specification of DiscDrive, and the destination area is the USA, among the management product group.

Option item identification information “DiscDrive” with the value of optional item “cd”, and optional item identification information “Area” with the value of optional item “jp” are associated with component identification information “CCC-c”. This shows that the components specified by the component identification information “CCC-c” are commonly used in products in which a CD drive is set as the specification of DiscDrive, and the destination area is Japan, among the management product group.

Option item identification information “DiscDrive” with the value of optional item “cd”, optional item identification information “Area” with the value of optional item “cn”, and optional item identification information “Price” with the value of optional item “H” are associated with component identification information “DDD-c”. This shows the components specified by the component identification information “DDD-c” are commonly used in products in which a CD drive is set as the specification of DiscDrive, the destination area is China, and which is high-priced among the management product group.

Option item identification information “DiscDrive” with the value of optional item “cd”, optional item identification information “Area” with the value of optional item “cn”, and optional item identification information “Price” with the value of optional item “L” are associated with component identification information “EEE-c”. This shows that the components specified by the component identification information “EEE-c” are commonly used in products in which a CD drive is set as the specification of DiscDrive, the destination area is China, and which is low-priced among the management product group.

Option item identification information “DiscDrive” with the value of optional item “cd”, and optional item identification information “Area” with the value of optional item “any: ex. us, jp, cn” are associated with component identification information “FFF-c”. This shows the components specified by the component identification information “FFF-c” are commonly used in products in which a CD drive is set as the specification of DiscDrive, and the destination area is country other than USA, Japan and China, among the management product group.

No option information is associated with component identification information “10-FFF-XX”, “A1010-21” and “P-21”. This shows that the components respectively specified by the component identification information “10-FFF-XX”, “A1010-21” and “P-21” are commonly used in all products in the management product group. That is, the component identification information with which option information is not associated is component identification information of the common components.

Option item identification information “EX” with the value of optional item “FDD” is associated with the component identification information “1139-FDD” and “P39-2”. This shows that the components respectively specified by the component identification information “1139-FDD” and “P39-2” are commonly used in products in which the floppy (registered trademark) disk drive is set as the specification, among the management product group. In this manner, the same optional item identification information and optional items value may be associated with the component identification information of the different components.

Further, the example shown in FIG. 2 is only an example, and the contents of the optional item identification information and the values of optional items are design matter. Further, how much option information is associated with one piece of component identification information is also a design matter.

Returning to FIG. 1, the product information holding unit 20 holds product information. The product information includes a list of product identification information which identifies each product in the management product group. Then, option designation information including the value of at least one of the optional items is associated with product identification information of at least one of the products.

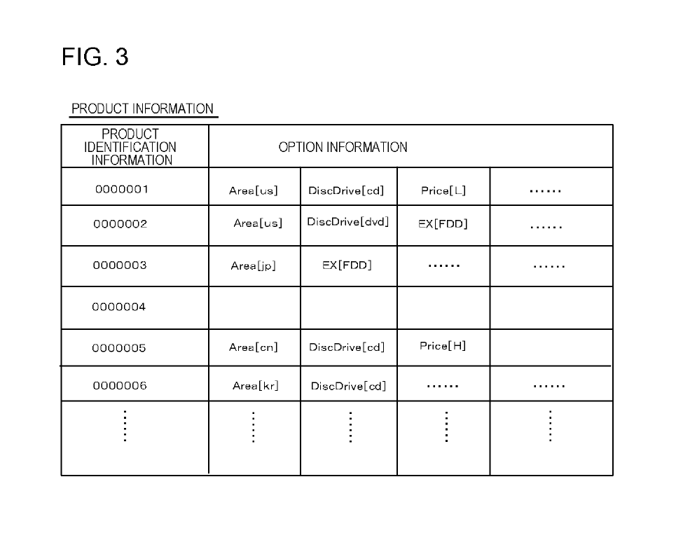

FIG. 3 illustrates an example of product information. In product information shown in FIG. 3, product identification information of each of a plurality of products is described in a column of product identification information. Then, optional item identification information which identifies optional items and the value of optional item are associated with and described in the column of option designation information.

For example, optional item identification information “Area” and the value of optional item “us”, optional item identification information “DiscDrive” and the value of optional item “cd”, and optional item identification information “Price” and the value of optional item “L”, and the like are associated with product identification information “0000001”. This shows that with respect to the product specified by product identification information “0000001”, the destination area is the USA, the CD drive is set by specification of DiscDrive, and the price is low.

Further, no option designation information is associated with product identification information “0000004”. This shows that the product specified by product identification information “0000004” uses no optional component.

Which option designation information is associated with each of the product identification information is a design matter that can be set in the process of planning and design of each product, and the content and the number thereof is not specially limited.

Returning to FIG. 1, the input receiving unit 30 receives, for example, an input to specify one piece of product identification information from the user. For example, the input receiving unit 30 may receive an input of one piece of product identification information itself, using various input apparatuses such as a keyboard, a mouse, a touch panel display, and an input button.

The product information search unit 40 searches, as a key, product information, using the designated product identification information that is product identification information specified according to the input that the input receiving unit 30 receives (referring to FIG. 3). Then, the product information search unit 40 acquires, as a search result, option designation information that is associated with the designated product identification information, or, information indicating that the option designation information is not associated with the designated product identification information.

For example, in a case where the designated product identification information is “0000001”, the product information search unit 40 searches product information shown in FIG. 3, and acquires as a search result, option designation information “Area[us]”, “DiscDrive[cd]”, and “Price[L]”.

Further, in a case where the designated product identification information is “0000004”, the product information search unit 40 searches product information shown in FIG. 3, and acquires as a search result, information indicating that the option designation information is not associated with the designated product identification information.

Returning to FIG. 1, the component extraction unit 50 searches component information (referring to FIG. 2), and extracts first component identification information that is component identification information which identifies the component of the product that is specified by the designated product identification information. The extraction process by the component extraction unit 50 is different depending on the search result that the product information search unit 40 acquires.

First, a case where the product information search unit 40 acquires the option designation information as the search result will be described.

In this case, the component extraction unit 50 extracts, as first component identification information, (1) component identification information (component identification information of common components) with which option information is not associated and (2) component identification information that the values of the associated optional items are included in option designation information that is search result, among component identification information (component identification information of optional components) with which option information is associated. Further, the component extraction unit 50 extracts as (2) component identification information, for example, component identification information that all values of the associated optional items are included in option designation information that is search result, among component identification information (component identification information of optional components) with which option information is associated.

As an example, it is considered a case where the designated product identification information is “0000001”, and the product information search unit 40, as a search result, acquires option designation information “Area[us]”, “DiscDrive[cd]”, and “Price[L]” (referring to FIG. 3).

In this case, the component extraction unit 50 searches for the component information shown in FIG. 2, and extracts as the first component identification information, component identification information “10-FFF-XX”, “A1010-21”, “P-21”, and the like in which (1) option information is not associated.

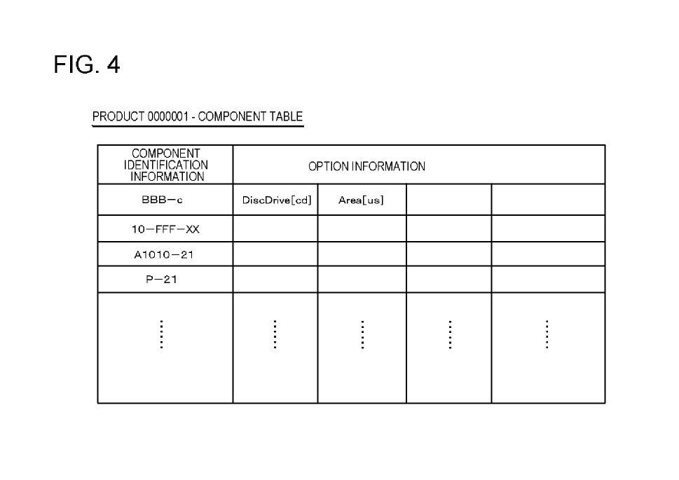

In addition, the component extraction unit 50 extracts as the first component identification information, component identification information that all values of the associated optional items are included in option designation information “Area[us]”, “DiscDrive[cd]”, and “Price[L]” that are search results, among component identification information “AAA-d”, “BBB-c”, “CCC-c”, “DDD-c”, “EEE-c”, “FFF-c”, “1139-FDD”, “P39-2”, and the like with which (2) option information is associated. In a case of the example, the component extraction unit 50 extracts component identification information “BBB-c” with which option information “Area[us]” and “DiscDrive[cd]” are associated. As a result, as shown in FIG. 4, the component table of the product designated by designated product identification information “0000001” is created.

In addition, among component identification information (component identification information of optional components) with which (2) option information is associated, an algorithm of a process of extracting component identification information that the value of the associated optional item is included in the option designation information is not particularly limited. However, a process of determining whether or not the value of the optional item associated with the first component identification information is included in the value of the optional item included in the option designation information that is a search result may be performed, for example, in the following manner.

First, the component extraction unit 50 recognizes optional item identification information (example: “DiscDrive” of FIG. 2) associated with the first component identification information (example: “AAA-d” of FIG. 2). Then, the component extraction unit 50 uses only the value of optional item (example: “cd”) associated with the recognized optional item identification information (example: “DiscDrive”) for determination among optional item values included in option designation information as the search result (example: option designation information associated with “0000001” of FIG. 3). That is, the component extraction unit 50 uses only the value of optional item (example: “cd”) associated with the recognized optional item identification information (example: “DiscDrive”) in a process for comparing with the value of optional item associated with the first component identification information (example: “AAA-d” in FIG. 2). This enables to improve efficiency of the comparison process.

Next, a description of a case where the product information search unit 40 acquires as a search result, information indicating that option designation information is not associated with the designated product identification information will be made.

In this case, the component extraction unit 50 extracts as the first component identification information, only (1) component identification information in which the option information is not associated (component identification information of common components).

For example, it will be considered a case where the designated product identification information is “0000004”, and the product information search unit 40, as the search result, acquires information indicating that option designation information is not associated with the designated product identification information (referring to FIG. 3).

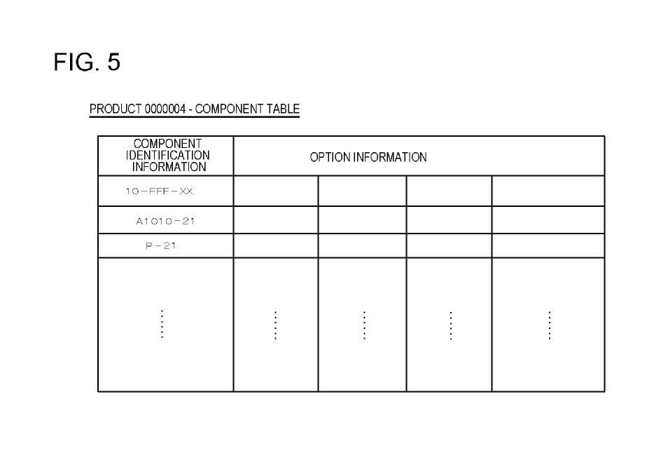

In this case, the component extraction unit 50 searches the component information shown in FIG. 2 and extracts as the first component identification information, only (1) component identification information in which option information is not associated, that is, “10-FFF-XX”, “A1010-21”, “P-21”, and the like. As a result, as shown in FIG. 5, the component table of the product designated by designated product identification information “0000004” is created.

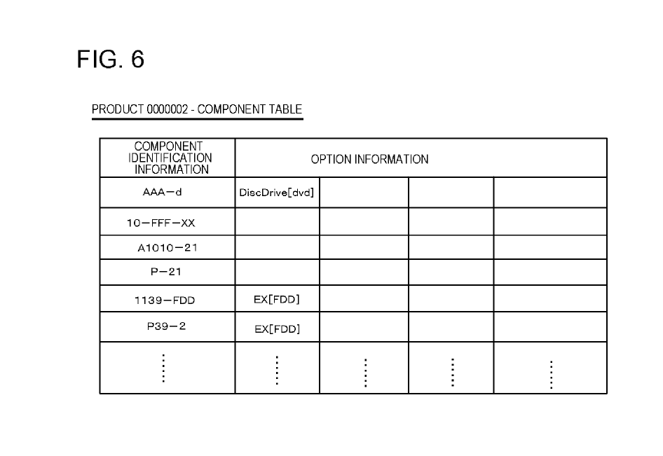

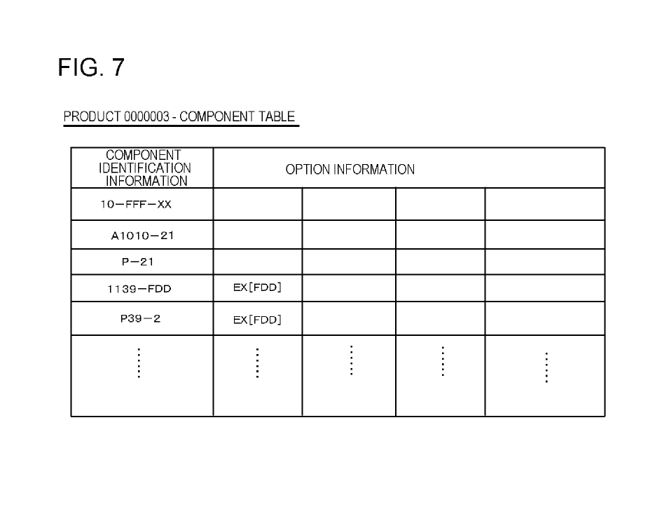

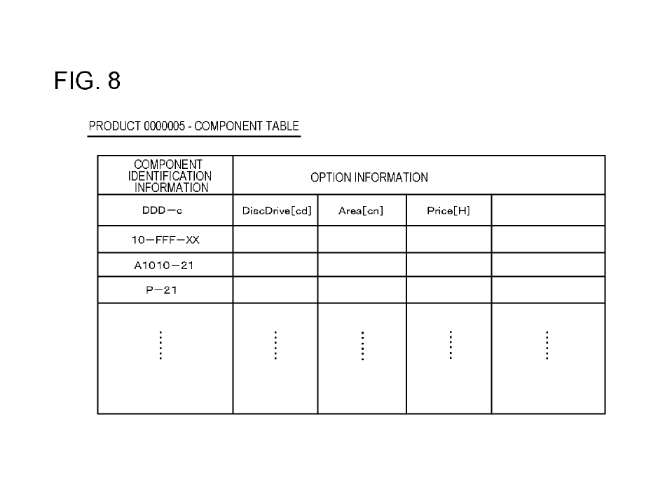

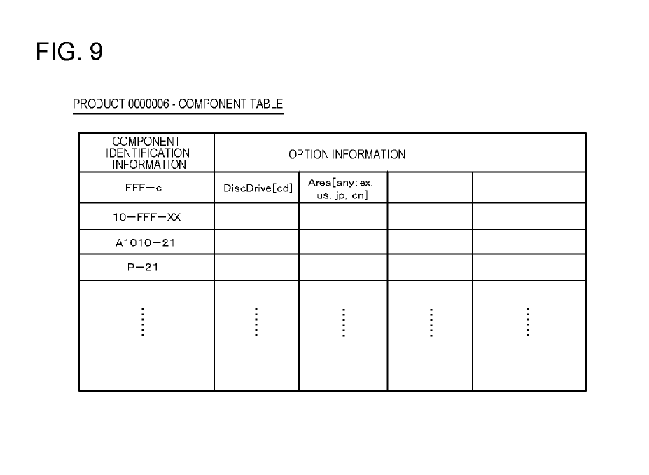

For reference, the component tables, created as the same manner as the above, of the products which each is designated byproduct identification information “0000002”, “0000003”, “0000005” and “0000006” (referring to FIG. 3) are respectively shown in FIGS. 6 to 9. According to the embodiment, as shown in FIGS. 6 and 7, a plurality of component identification information may be extracted from the same value of the optional item. In FIGS. 6 and 7, there are illustrated an example in which from the value of optional item “FDD”, the component identification information “1139-FDD” and “P39-2” are extracted.

Returning to FIG. 1, the output unit 60 outputs first component identification information extracted from the component extraction unit 50. For example, the output unit 60 outputs the component table shown in FIGS. 4 to 9 that is created using the first component identification information extracted by the component extraction unit 50 through various output apparatuses such as a display, a printing apparatus, and the like.

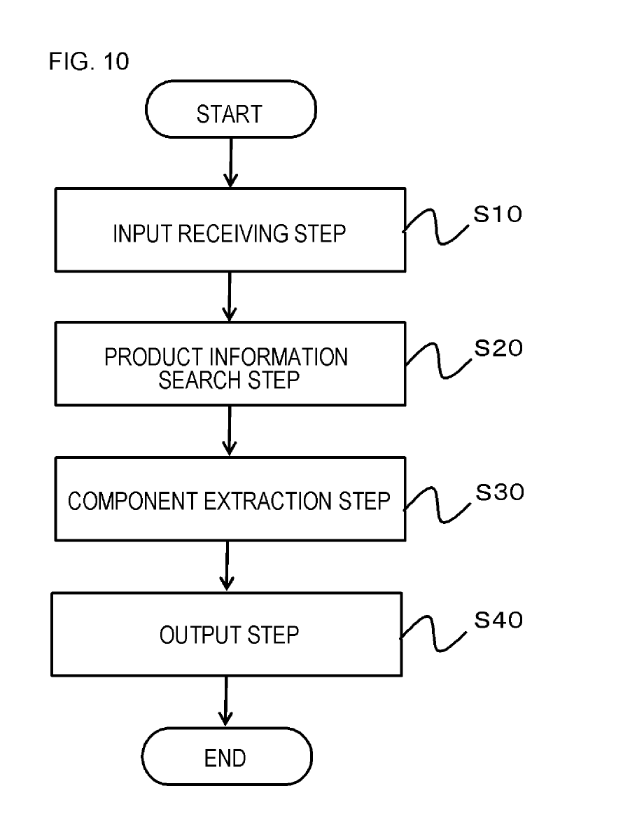

Next, the flow of the process of the component management method of the embodiment will be described. The component management method of the embodiment includes, as shown in the flowchart of FIG. 10, an input receiving step S10, a product information searching step S20, a component extracting step S30, and output step S40.

In the input receiving step S10, the input receiving unit 30 receives, for example, an input to specify one piece of product identification information from the user.

In the product information search step S20, the product information search unit 40 searches the product information (referring to FIG. 3) that the product information holding unit 20 holds, using the designated product identification information that is product identification information specified according to the input in S10, as a key. Then, the product information search unit 40, as the search result, acquires the option designation information associated with the designated product identification information or information indicating that option designation information is not associated with the designated product identification information.

In the component extraction step S30, the component extraction unit 50 searches the component information (referring to FIG. 2) that the component information holding unit 10 holds, and extracts the first component identification information that is the component identification information which identifies the components of the product specified by the designated product identification information.

To be specific, in S20, in a case where the product information search unit 40 acquires as the search result, the option designation information, the component extraction unit 50 extracts, as the first component identification information, (1) component identification information (component identification information of common components) with which option information is not associated and (2) component identification information that the values of the associated optional items are included in option designation information that is search result, among component identification information (component identification information of optional components) with which option information is associated. Further, the component extraction unit 50 extracts as (2) component identification information, for example, component identification information that all values of the associated optional items are included in option designation information that is a search result, among component identification information (component identification information of optional components) with which option information is associated.

On the other hand, in S20, in a case where the product information search unit 40 acquires information indicating that the option designation information is not associated with the designated product identification information as the search result, the component extraction unit 50 extracts only (1) component identification information (component identification information of common components) with which option information is not associated, as the first component identification information.

In an output step S40, the output unit 60 outputs the first component identification information that is extracted by the component extraction unit 50 in S30. For example, the output unit 60 outputs the component table that is created using the first component identification information that is extracted by the component extraction unit 50, shown in FIGS. 4 to 9, through various output apparatuses such as a display, and a printing apparatus.

Further, the component management apparatus 1 of the embodiment can be realized by installing, for example, the following program in the computer.

A program which arranges and manages components of a plurality of products, the program causing a computer to function as:

a component information holding unit that holds component information in which component identification information of common components that are common in all of the plurality of products among the components and component identification information of optional components which are different for each product among the components are listed, and option information including a value of at least one of the optional items is associated with the component identification information of the optional components;

a product information holding unit that holds product information in which product identification information of each of the plurality of products is listed, and option designation information including a value of at least one of the optional items is associated with the product identification information of at least one of the products;

an input receiving unit that receives an input to specify one of the product identification information;

a product information search unit that searches the product information, using designated product identification information that is the product identification information specified by the input as a key, and acquires the option designation information associated with the designated product identification information, or information indicating that the option designation information is not associated with the designated product identification information, as a search result; and

a component extraction unit that searches the component information, and extracts first component identification information that is the component identification information of the component of the product specified by the designated product identification information,

wherein in a case where the product information search unit acquires the option designation information as the search result, the component extraction unit is caused to function in order to extract the component identification information in which the values of the associated optional items are included in the option designation information, as the first component identification information, among the component identification information with which the option information is associated.

According to the embodiment, it is possible to facilitate a creation and management of a component table. For example, in a case where a new product comes out, which uses all common components that are registered in component information and uses a part of optional components that are registered in advance in the component information, if information which identifies the new product and the values of at least one of the optional items indicating requirements specific to the new product are associated with and registered in the product information, it is possible to create a component table of the new product without changing the content of the component information. That is, it is not necessary to change the content of the component information whenever the new product comes out.

In addition, according to the embodiment, even in a case whether or not each product uses optional components is determined by one requirement specific to each product, or two or more requirements specific to each product, it is possible to properly associate each product and optional components with a relatively easy data configuration.

This application claims a priority based on Japanese Patent Application No. 2011-010105 filed on Jan. 20, 2011, and the entire disclosure is incorporated herein.

What is claimed is:

1. A component management apparatus which arranges and manages components of a plurality of products comprising:
a component information holding unit that holds component information in which component identification information of common components that are common in all of the plurality of products among the components and component identification information of optional components which are different for each product among the components are listed, and option information including a value of at least one of optional items is associated with the component identification information of the optional components;
a product information holding unit that holds product information in which product identification information of each of the plurality of products is listed, and option designation information including a value of at least one of the optional items is associated with the product identification information of at least one of the products;
an input receiving unit that receives an input to specify one of the product identification information;
a product information search unit that searches the product information, using designated product identification information that is the product identification information specified by the input as a key, and acquires the option designation information associated with the designated product identification information, or information indicating that the option designation information is not associated with the designated product identification information, as a search result; and
a component extraction unit that searches the component information, and extracts first component identification information that is the component identification information of the component of the product specified by the designated product identification information,
wherein in a case where the product information search unit acquires the option designation information as the search result, the component extraction unit extracts the component identification information in which the values of the associated optional items are included in the option designation information, as the first component identification information, among the component identification information with which the option information is associated.

2. The component management apparatus according to claim 1,
wherein in the component information, the option information including the value of at least one of the optional items is associated with the component identification information of the first optional components, and the option information including the optional item value of two or more is associated with the component identification information of second optional components.

3. The component management apparatus according to claim 1,
wherein in the component information, the option information is not associated with the component identification information of the common components, and
wherein in a case where the product information search unit acquires the option designation information as the search result, the component extraction unit further extracts the component identification information with which the option information is not associated, as the first component identification information.

4. The component management apparatus according to claim 1,
wherein in the component information, the option information is not associated with the component identification information of the common components, and
wherein in a case where the product information search unit acquires information indicating that the option designation information is not associated with the designated product identification information as the search result, the component extraction unit extracts only the component identification information with which the option information is not associated, as the first component identification information.

5. The component management apparatus according to claim 1,
wherein optional item identification information of the optional items associated with the optional item values is included in the option information,
wherein optional item identification information which identifies the optional items associated with the optional item values is included in the option designation information, and
wherein in a process of determining whether or not all of the values of the optional items included in the option information associated with the first component identification information are included in the values of the optional items included in the option designation information, the component extraction unit recognizes the optional item identification information included in the option information, and uses only the values of the optional items associated with optional item identification information that is recognized among the values of the optional items included in the option designation information.

6. A component management method which arranges and manages components of a plurality of products, the method comprising:
in a state where component information and product information are stored in a memory,
in the component information, component identification information of common components that are common in all of the plurality of products among the components and component identification information of optional components which are different for each product among the components are listed, and option information including a value of at least one of optional items is associated with the component identification information of the optional components, and
in the product information, product identification information of each of the plurality of products is listed, and option designation information including a value of at least one of the optional items is associated with the product identification information of at least one of the products,
an input receiving step that receives an input to specify one of the product identification information;
a product information search step that searches the product information, using designated product identification information that is the product identification information specified by the input as a key, and acquires the option designation information associated with the designated product identification information, or information indicating that the option designation information is not associated with the designated product identification information, as a search result; and
a component extraction step that searches the component information, and extracts first component identification information that is the component identification information of the component of the product specified by the designated product identification information,
wherein in a case where the product information search step acquires the option designation information as the search result, the component extraction step extracts the component identification information in which the values of the associated optional items are included in the option designation information, as the first component identification information, among the component identification information with which the option information is associated.

7. A non-transitory storage medium storing a program which arranges and manages components of a plurality of products, the program causing a computer to function as:
a component information holding unit that holds component information in which component identification information of common components that are common in all of the plurality of products among the components and component identification information of optional components which are different for each product among the components are listed, and option information including a value of at least one of optional items is associated with the component identification information of the optional components;
a product information holding unit that holds product information in which product identification information of each of the plurality of products is listed, and option designation information including a value of at least one of the optional items is associated with the product identification information of at least one of the products;
an input receiving unit that receives an input to specify one of the product identification information;
a product information search unit that searches the product information, using designated product identification information that is the product identification information specified by the input as a key, and acquires the option designation information associated with the designated product identification information, or information indicating that the option designation information is not associated with the designated product identification information, as a search result; and
a component extraction unit that searches the component information, and extracts first component identification information that is the component identification information of the component of the product specified by the designated product identification information,
wherein in a case where the product information search unit acquires the option designation information as the search result, the component extraction unit is caused to function in order to extract the component identification information in which the values of the associated optional items are included in the option designation information, as the first component identification information, among the component identification information with which the option information is associated.
